(19) United States
(12) Patent Application Publication
(10) Pub. No.: US 2015/0154587 A1
(43) Pub. Date: Jun. 4, 2015

(54) SYSTEM AND METHOD FOR APPLYING CREDITS FROM THIRD PARTIES FOR REDEMPTION AT MEMBER RETAILERS

(71) Applicant: Vijay Raghavan Chetty, Santa Monica, CA (US)

(72) Inventor: Vijay Raghavan Chetty, Santa Monica, CA (US)

(21) Appl. No.: 14/620,058

(22) Filed: Feb. 11, 2015

Related U.S. Application Data
(63) Continuation-in-part of application No. 12/909,603, filed on Oct. 21, 2010.
(60) Provisional application No. 61/285,911, filed on Dec. 11, 2009.

(51) Int. Cl. G06Q 20/34; G06Q 20/24

(52) U.S. Cl. CPC G06Q 20/342; G06Q 20/24

(57) ABSTRACT

According to one embodiment of the invention, a credit redemption system allows a registered user to transmits a request to deposit an amount on a gift card directed to a first retail member and, after verifying that the user has established an account with the credit redemption system, the credit redemption system will deposit the amount on the gift card into the sub-account corresponding to the first retail member. The user may further use the account to make purchases from the first retail member and the amount of the purchase will be deducted from the sub-account corresponding to the first retail member. Furthermore, the user may have a plurality of sub-accounts within the user's account with each sub-account corresponding to a separate retail member.

### CROSS-REFERENCE TO RELATED APPLICATIONS

This application is a continuation-in-part of and claims benefit of priority on U.S. patent application Ser. No. 12/909,603, which claims the benefit of priority on U.S. Provisional Application No. 61/285,911 filed Dec. 11, 2009, the contents of both of which are incorporated by reference.

### FIELD

Embodiments of the invention relate to the field of credit management. In particular, certain embodiments of the invention relate to a system and method for applying credits received from registered members of a credit redemption system to a recipient's holding account and making these credits available for redemption at one or more retailers that are registered with the credit redemption system.

Another embodiment of this invention relates to redemption of digital credits from the recipients' holding accounts for purchases by recipients at member retailers and all other merchants (both online and brick and mortar merchants).

### GENERAL BACKGROUND

Billions of dollars' worth of gift cards are purchased each year with a high percentage of these gift cards being lost, stolen or unused. Hence, a mechanism is needed that can enable the use of gift cards and digital promotional materials seamlessly and encourage people to visit retailers more regularly.

Giving gift cards to friends and family for various occasions such as birthdays, weddings, anniversary etc., has been common for decades. Virtual gift cards (online and mobile) are gaining popularity. An estimated $100 Billion dollars of gift cards are purchased each year in the United States alone. Industry statistics show that one in five gift cards or $20 Billion of gift cards are never used. Consumers receive numerous types of gift cards (such as Visa gift cards, hotel/restaurant gift cards, retail store gift cards like Macy's, Nordstrom, etc.) from friends and family for various occasions. All of these gift cards are for a pre-determined value and once the value of the gift card is used, the gift card is worthless and thrown away. Many of these gift cards have expiration dates and become worthless if not used before expiration date. Since consumers receive numerous gift cards (typically for small amounts such as $10, $25 or $50), they tend to forget, misplace or lose them.

### BRIEF DESCRIPTION OF THE DRAWINGS

The invention may best be understood by referring to the following description and accompanying drawings that are used to illustrate embodiments of the invention.

FIG. 1 is a first exemplary embodiment of a Credit Redemption System (CRS).

FIG. 2 is a second exemplary embodiment of the Credit Redemption System (CRS).

FIG. 3A is an exemplary embodiment of the architecture of the electronic device of FIGS. 1 and 2.

FIG. 3B is an exemplary embodiment of operations for configuring the electronic device of FIG. 3A to support digital credit uploading into a centralized holding account for the recipient.

FIGS. 4A-4G are exemplary embodiments of POS controller and POS terminals that support digital credit uploading and redemption by the CRS.

FIG. 5 is an exemplary embodiment of the digital credit distribution process supported by the credit redemption system.

FIG. 6 is an exemplary embodiment of the process of registering a new user, establishing a holding account and issuing ‘prepaid reloadable gift/debit card’ linked to the holding account of the registered user.

FIG. 7 is an exemplary embodiment of the process of ‘Credit Email Message’ received or sent by a registered user and adding or deducting the value of the digital credit from/to their holding account.

FIG. 8 is an exemplary embodiment of a ‘Universal Reloadable Prepaid Gift Card’ linked to the ‘Holding Account’ of the recipient to facilitate redemption of digital credits by the recipient from his/her holding account for purchases and other redemptions by the recipient at member retailers and all other merchants (both online and brick and mortar merchants).

FIG. 9 is an exemplary embodiment of a system that tracks the registered user of CRS online and pre-fills all the necessary payment information at checkout pages of the member retailers' websites to facilitate completion of the online order by the registered user and payments directly from the registered users' holding account to the online merchant on behalf of the registered user.

FIG. 10 is an exemplary depiction of a website displayed by an application on an electronic device illustrating the holding account of a user registered.

### DETAILED DESCRIPTION

Exemplary embodiments of the invention refer to numerous methods for improving the convenience for consumers and retailers wherein all gift cards, also referred to generally as gifts, received by a consumer from all sources are combined into one ‘Universal Gift Account’ (hereinafter referred to as holding account as described below). Furthermore, the Universal Gift Account may be linked to one ‘Universal Prepaid Gift Card’ (both physical and virtual) for each consumer so that all gifts received by a consumer from all sources are saved in one holding account and will always be available for use. Since the value of the holding account of each consumer will increase for additional gifts received from others and decrease for redemptions or purchases paid out of this holding account, the spending limit on this ‘Universal Prepaid Gift Card’ that is linked to this holding account should also increase or decrease based on the balance in their holding account in real time. In one embodiment, the Universal Prepaid Gift Card shall function like a debit card and may be issued by any debit or credit card companies such as Visa, Master Card, American Express or Discover.

Further, the gifts received from various sources can be categorized and accumulated within their holding account by retailer or type of gift received such as Macy's, Home Depot or Cash. As an example, if a consumer received five Macy's virtual gifts for $20 each, five Home Depot virtual gifts for $25 each and five virtual cash gifts for $30 each, then the gift cards will be categorized and accumulated within the holding account of the recipient as follows: total Macy's virtual gift: $100; total Home Depot virtual gift: $125; and total cash gift: $150. The total Macy's accumulated virtual gift balance within the holding account can only be redeemed at Macy's.

This Universal Prepaid Gift Card that is linked to the recipients' holding account should work at all retailers and merchants that accept prepaid debit cards. This holding account, directly or indirectly through other payment solutions and networks, shall work as the authentication source for approving or rejecting dollar value of transactions and spending limits.

Note that under the current system, ‘Prepaid Debit Cards’ are issued to a consumer with certain spending limits based on the balance in their prepaid debit card account. Today, only the consumer to whom the prepaid debit card is issued can re-load additional amount into their prepaid debit card account through direct deposits. Since gift cards are purchased by a consumer and issued to someone else, they are for a pre-determined value and are not re-loadable by either the issuer or the recipient. As of today, there's no re-loadable gift card in the market.

Further, consumers like to keep track of the type and amounts of gifts received from their friends and family so that they can reciprocate with similar gift type and/or value to them at a future date for various occasions. As an example, let's say John Doe received the following birthday gifts: $25 from A; $50 from B; $75 from C and $100 from D. John would like to reciprocate similarly with a gift having an approximate value of $25 for A's birthday and a gift having an approximate value of $100 for D's birthday. It will be helpful and convenient for consumers if this holding account kept track of all gifts sent and received from various people and sources over a period of time so that they do not manually have to keep track of all gifts received and given over a period of time to their friends and family.

While consumers can send and receive online and mobile gifts today, each gift sent or received is considered a separate gift and the gifts are not combined together into one holding account. Further, there is no mechanism to seamlessly redeem gifts from this holding account. Since gift cards are issued by millions of business entities, purchased by millions of consumers and distributed to millions of consumers, a system to send and receive gifts electronically via email or cellular/wireless text message, combine all gifts received by a consumer from all sources into one holding account and seamlessly redeem all gifts and digital credits from their holding account will simplify the process, make it convenient for consumers to send, receive and use gifts, keep track of all gifts sent and received from various people over a period of time and eliminate waste.

Embodiments of this invention relate to the electronic exchange of gifts between consumers and electronic redemption by recipient consumer at member retailers' and all other merchants (both online and brick and mortar merchants). Herein, business entities registered to participate in the ‘Credit Redemption System (CRS)’ are referred to as ‘member retailers’ and all other business entities not registered in the CRS are referred to as ‘Merchants’.

Exemplary embodiments of the invention relate to a system and method for receiving digital credits by a recipient and making these credits available for redemption at one or more retailers that have joined a Credit Redemption System (CRS).

According to one embodiment of the invention, digital credits are given as gifts between registered users of a credit redemption system who are in communication over a network. The network may be a private network or a public network (e.g., the Internet) and the communications may be over a medium that supports wireless communications (e.g., infrared “IR”, laser, radio frequency, cellular, Bluetooth®, satellite, etc.) or wired communications (e.g., electrical wire, optical fiber, cable, etc.). After receipt of digital credits by one of the registered users (hereinafter referred to as a “recipient”), these digital credits are uploaded and remotely stored for later retrieval for redemption by a retailer that is also a registered member of the credit redemption system.

Other embodiments of the invention relate to a system and method for sending and receiving digital credits via email and redeeming digital credits from the recipients' holding accounts for purchases by recipients at member retailers and all other merchants (both online and brick and mortar merchants).

In yet other embodiments of the invention, a system and method for sending and receiving digital credits via an electronic signal wherein the user receives a notification on an electronic device alerting the recipient to the digital credit gift. Furthermore, the recipient may then access the digital credit gift and the recipient's holding account from the electronic device and redeem the digital credits from the holding account for purchases by the recipient at member retailers and all other merchants.

In the following description, certain terminology is used to describe certain features of the invention. For example, the term “retailer” constitutes an entity that is involved with the selling of items, namely products and/or services. An “electronic device” is a device that processes input data and supports network connectivity to upload digital credits into a credit storage unit (e.g., any local or remote device that provides data storage for monetary credits such as a server, dedicated hard disk drive array, etc.) that is accessible by one or more retailers. Examples of an electronic device include, but are not limited or restricted to a computer (e.g., desktop, laptop, netbook, mainframe with one or more terminals), a personal digital assistant, a cellular telephone, a tablet, a kiosk, or the like.

The term “digital credit” generally describes pre-paid monies that may be applied to a balance owed or authorization to debit an account for an amount equivalent to the value of the digital credit. For instance, as an illustrative embodiment of the invention, the digital credit may be alphanumeric (or numeric-only) characters or even a string of bits that specify a monetary credit amount readable by a point-of-sale (POS) system.

According to another embodiment of the invention, a digital credit may be an image that identifies a monetary credit value. For instance, the image may be a barcode in accordance with any one of the commonly accepted barcode formats such as Universal Product Code (UPC), International Article Number (EAN), Code 39, Code 128, GS1 DataBar, or the like.

According to another embodiment of the invention, the balance of the digital credit in the ‘holding account’ of a registered user may be uploaded or downloaded into a smart chip of a smart card to facilitate redemption of digital credits at member retailers and all other merchants. In yet another embodiment of the invention, a prepaid debit and/or gift card may be issued to a registered user (the recipient) that links the prepaid debit or gift card to the ‘holding account’ of the recipient so that the balance available for redemption increases for the digital credits received in the holding account of the recipient from other registered users and decreases for redemption of digital credits from the holding account by the recipient.

Herein, the terms “logic,” “unit” and “module” constitute hardware and/or software. In general terms, hardware constitutes physical components while software constitutes code or a series of coded instructions that may be implemented as firmware or may be implemented as part of an operating system, an application program, a downloadable applet, a routine, or the like. For instance, a module can be stored in any type of machine readable medium and executed by a processing unit. Examples of “machine readable medium” include a programmable electronic circuit, a semiconductor memory device including volatile memory (e.g., random access memory, etc.) or non-volatile memory (e.g., any type of read-only memory “ROM”, flash memory), an optical disk (e.g., compact disk or digital video disc “DVD”), a hard drive disk, a portable drive (e.g., Universal Serial Bus “USB” flash drive), or the like. Examples of a “processing unit” comprise a digital signal processor, a general microprocessor, a micro-controller, a state machine, an application specific integrated circuit, or the like.

A. Exemplary System Architectures

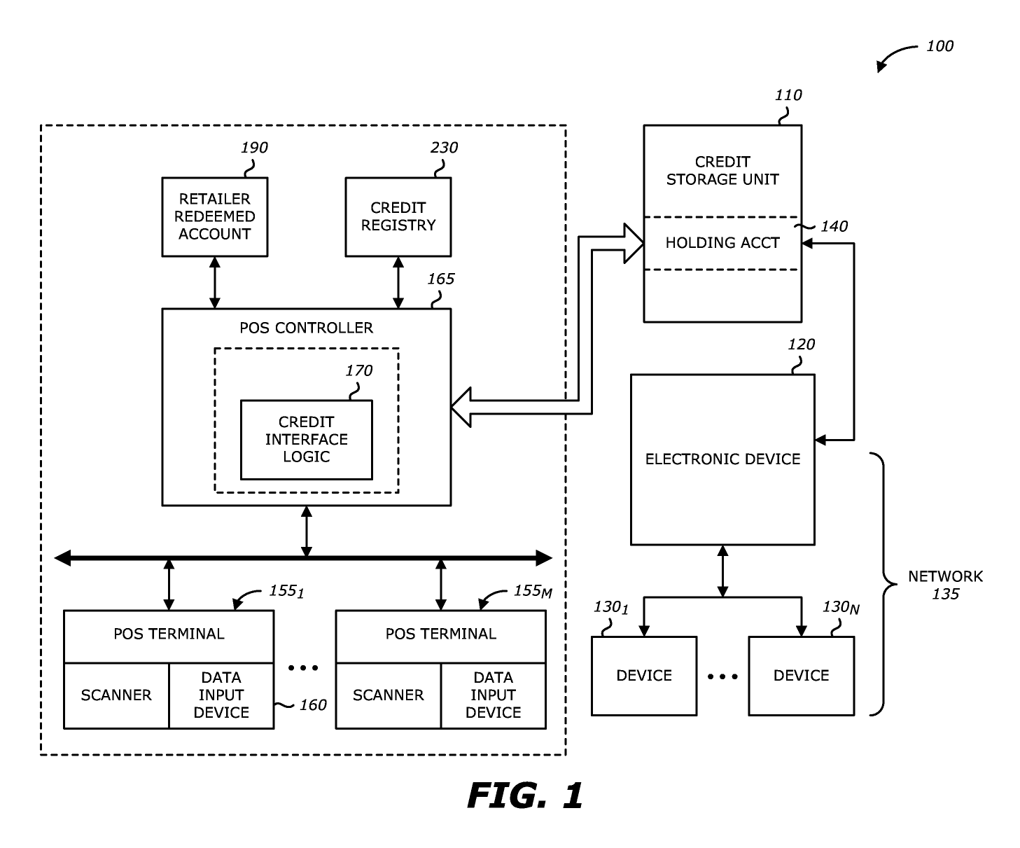

Referring now to FIG. 1, a first exemplary embodiment of a Credit Redemption System (CRS) 100 is illustrated. CRS 100 comprises a credit storage unit 110 that is in communication with and configured to receive and store digital credits uploaded by a registered user (hereinafter referred to as “recipient”) via an electronic device 120. As described below, at some point, the recipient is required to register with CRS 100. This may be accomplished by accessing a website and providing demographic and/or other information such as at least two or more of the following: name, age, electronic mail (email) address, mailing address, phone number, biometric (e.g., fingerprint image, retinal scan, facial geometry), funding source (e.g., credit card number, debit card number with pin, bank account routing number, PayPal® account, etc.), loyalty card number, personal identification number (PIN), and/or income range. Of course, in lieu of accessing the website, the user may register by simply filling out paperwork that is sent to an agency that registers the user.

According to this embodiment of the invention, after registration, a storage area 140 is allocated for the registered user (or group of users) within a credit storage unit 110. Herein, the user(s)-specific storage area 140 may be referred to as a “holding account.”

According to one embodiment of the invention, credit storage unit 110 constitutes one or more servers that are not only accessible by one or more retailers that are members of CRS 100, but also are adapted to store digital credits that are exchanged between registered users (e.g., provided by a registered consumer to a registered recipient). However, in lieu of a server implementation, it is contemplated that credit storage unit 110 may be any form of data storage that is accessible by a retailer and is configured to receive uploaded digital credits from a registered recipient who may be current, potential or former customers of the retailer.

According to another embodiment of the invention, all digital credits exchanged between registered users are stored in credit storage unit 110 under the respective recipients' holding accounts 140.

As shown in FIG. 1, it is evident from the illustrative embodiment that digital credits may be routed over a network 135 that features electronic device 120 controlled by recipient and other electronic devices 130₁-130_{N} (N>1) controlled by various registered users. As a result, a member of CRS 100 is able to send an electronic mail (email) message from device 130ᵢ (i=1 . . . , or N) to the recipient associated with electronic device 120. This email message is referred to as a “credit email message” since, after the email is opened, it will enable the recipient to upload credits identified in the message into the recipient's holding account 140.

As an example, upon accessing a particular web site, a consumer may select to send a credit email message to be sent to the recipient. If the consumer is a registered member of CRS 100, the consumer will be able to access the web site, identify the intended recipient (e.g., email address and/or name of recipient), and the amount of credit to be given. As an optional feature, an existing funding source identified in the registration process may be selected or a different funding source may be selected or entered.

After this information is entered, the consumer will cause a credit email message to be sent to the recipient from which the credit amount can be uploaded into the recipient's holding account, provided the recipient is registered with CRS 100. The credit uploading process may be initiated upon selection of a link within the credit email message. The funding of the credit (i.e., debiting of the funding source selected by the consumer) can occur prior to transmission of the email message, once the credit is uploaded into the recipient's holding account, or when the credit is redeemed by the retailer.

As an alternative, before the credit amount is uploaded to the recipient's holding account, a verification process may be established to verify that the credit email message is in possession of the intended recipient. Such verification may be after establishing a secure communication path with credit storage unit 110 (e.g., secure socket layer “SSL” communication session). The verification may be in accordance with biometric information (e.g., fingerprint image) uploaded into credit storage unit 110, entry of a predetermined pass-phrase, or the like. It is contemplated, however, that the verification may occur prior to establishing a secure communication path with credit storage account 110. Such verification may be accomplished by a variety of techniques. For instance, the credit email message may feature an entry for the recipient to answer a question that the consumer knows the answer, has provided the answer when generating the credit email message and the answer has undergone a one-way hash function or other cryptographic operation to obfuscate the content of the answer.

As another alternative, the recipient does not receive a credit email message but instead receives a notification to an electronic device. In one embodiment, the user may have an application downloaded and installed on an electronic device and a pop-up notification alerts the recipient to the digital credit received from the consumer. Examples of the electronic device include, but are not limited or restricted to, a cellular device, a tablet, or a personal digital assistant (PDA). The alert received by the recipient may be a pop-up that appears on a display screen of the electronic device and immediately discloses the digital credit gift to the recipient. Alternatively, the alert may be any image that appears on the screen of the electronic device that allows a user to visually understand that a digital gift has been received. According to another embodiment of this invention, other than allowing registered users to upload digital credits into holding account 140, it is contemplated that credit issuers (e.g., retailers, manufacturers and third parties) registered to participate in this credit network, may be given access to the users' holding accounts to load any credit directly into each user's holding account. Alternately, these credit issuers may electronically transmit their credits to credit storage unit 110 for subsequent distribution and allocation to the respective users' holding accounts based on certain criteria defined by the credit issuers. For instance, credits distributed to registered users may vary depending on the amount of purchasing activity by each registered user. In other words, a first registered user may receive a rebate for 10% off his/her next purchase for a particular member retailer based on the amount of the first registered user's recent purchase and a second registered user may receive a rebate for 5% off his/her next purchase if the second registered user's recent purchase was less than the first registered user's recent purchase. This way, a member retailer may reward registered users for their spending on its products or incentivize registered users to make further purchases.

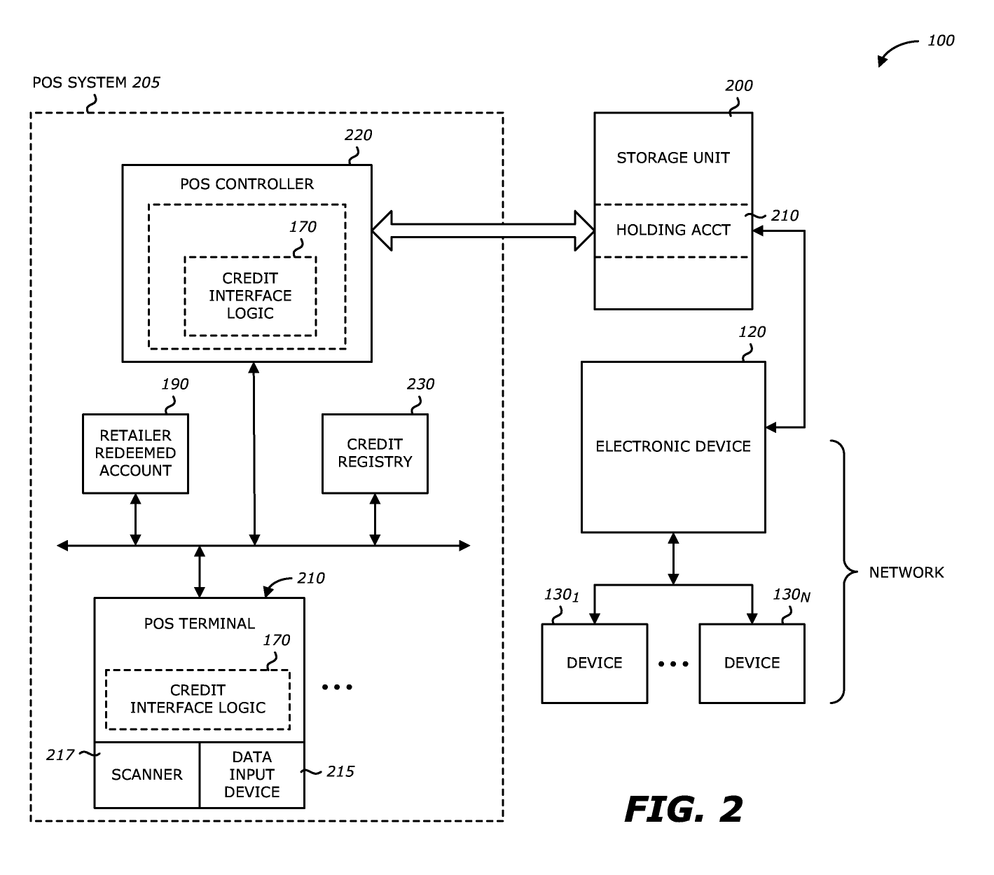

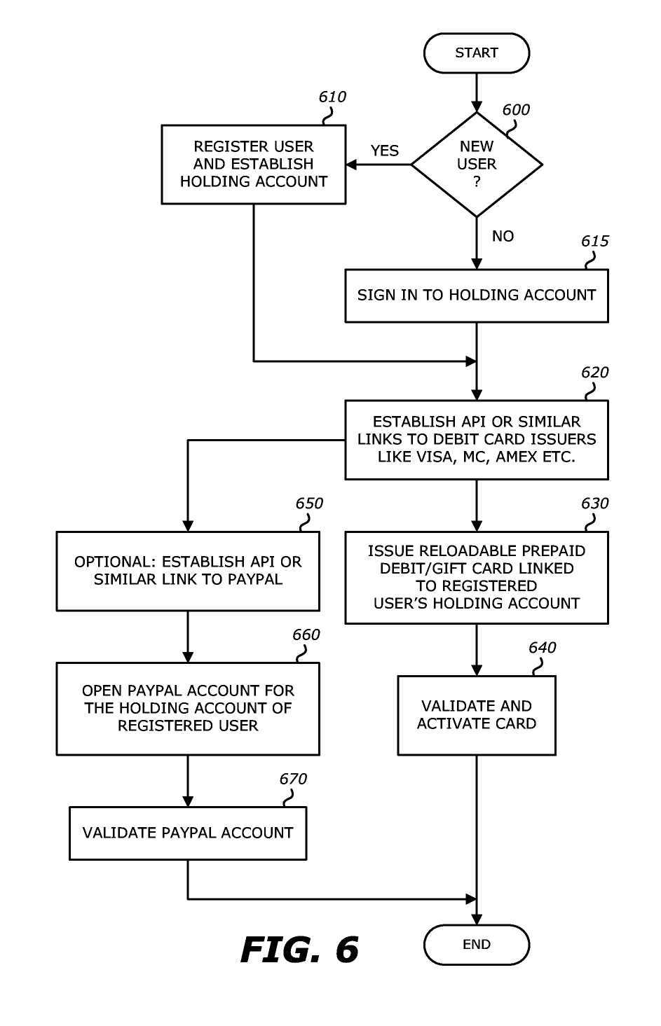

Upon exchange of digital credits between registered users via credit email message or electronic transmission with a notification on an electronic device, the digital credits are uploaded and stored in the recipients' holding accounts. The digital credits stored in the recipients' holding accounts can now be redeemed by the recipient in many different ways. Some examples include, but are not limited or restricted to:
i) By sending a ‘Credit Email Message’ to other registered users of the CRS, which will redeem/subtract the value of gifts/digital credits from their holding accounts as shown in FIGS. 1 through 5 and described above.
ii) By direct interface/integration to the point of sale (POS) system of member retailers as shown in FIGS. 2 to 5, wherein the balance due to the member retailer for purchases by registered user can be applied directly from the holding account of the registered user as described below.
iii) By issuing a ‘Universal Reloadable Prepaid Debit/Gift Card’ to a registered user that links the reloadable prepaid debit or gift card to the ‘holding account’ of the registered user so that the balance available for redemption increases for gifts/digital credits received in the holding account from other registered users and decreases for gifts/digital credits sent by registered user to others from his/her holding account, as shown in FIGS. 6 to 9 and described herein. The balance in the holding account also decreases for purchases and other redemptions using the prepaid reloadable gift/debit card and/or PayPal® account that is linked to the holding account of the registered user.
iv) A system and method that tracks the registered users online from the web pages of the CRS and pre-fills all the necessary payment information at checkout pages of the merchants' web sites to facilitate completion of the online order by the recipient and payments directly from the recipients holding account to the online merchant on behalf of the recipient.

I) Redemption of Digital Credits from ‘Holding Accounts’ of Registered Users Via Direct Interface/Integration to POS Systems of Member Retailers:

Upon checkout, a point of sale (POS) terminal 155ⱼ (j=1 . . . , or M, where M≧1) identifies the recipient based on information received via a data input device 160 (e.g., keypad, touch screen, barcode or magnetic strip obtained via a card scanner). After such identification, POS terminal 155ⱼ signals a credit interface logic 170, which is controlled by POS controller 165, to fetch the digital credits retained in recipient's holding account 140. These digital credits may be stored locally at POS controller 165, may remain in holding account 140 and retrieved upon computing a subtotal (or total) purchase price, or transferred to another storage location that provides reduced fetching latency of credits by POS terminal 155ⱼ.

According to one embodiment of the invention, where credit validation is not performed, credit interface logic 170 reviews the recovered digital credits for the registered recipient to see if the total purchase price exceeds the total amount of digital credits held by the registered recipient. If so, the total amount of digital credits is transmitted to POS terminal 155ⱼ for processing.

However, if the total amount of digital credits exceeds the total purchase price for the selected item(s), credit interface logic 170 transfers the digital credits equal to the total purchase price to POS terminal 155ⱼ and deducts the total purchase price from the total amount of digital credits. This difference is returned (i.e. uploaded) to the recipient's holding account 140 for future use. The applied digital credit is then added to the retailer's account of redeemed credits (hereinafter referred to as “retailer redeemed account 190”) for recordation of credit applied for accounting purposes (e.g., collection of monies owned by the controlling entity of credit storage unit 110, commissions paid to the controlling entity of credit storage unit 110, etc.).

Referring now to FIG. 2, a second exemplary embodiment of Credit Redemption System (CRS) 100 is illustrated. CRS 100 comprises at least one storage unit 200 that are accessible by a point-of-sale (POS) system 205 that is implemented at the retailer. According to one embodiment of the invention, the retailer may be selected by the recipient to have access to recipient's holding account 140, although it is contemplated that access may be restricted by the recipient or made available to all retailers that are registered with CRS 100.

Herein, digital credits from the recipient are uploaded into credit storage unit 200 via electronic device 120 in response to selection of a link in a credit email message as describe above. Credit storage unit 200 may be local to the retailer or may be placed off-site.

Each user is assigned an amount of storage within storage unit 200. This amount of storage is referred to as the user's “holding account.” The digital credit may be subsequently accessed by a POS controller 220 or POS terminal 210 situated as part of retailer's POS system 205, depending on the POS configuration.

Upon checkout, POS terminal 210 identifies the recipient based on information received via a data input device 215 (e.g., keypad, touch screen, barcode or magnetic strip obtained via a card scanner) or scanner 217. After such identification, POS terminal 210 (or POS controller 220) fetches the digital credits that are assigned to the recipient and were previously uploaded in storage unit 200. The fetching of the digital credits may be performed by credit interface logic 170 implemented within POS terminal 210 (or POS controller 220) and optionally validated by such logic as described below.

1. Credit Validation by Credit Interface Logic

According to one embodiment of the invention, as items are scanned at POS terminal 210, credit interface logic 170 implemented at POS terminal 210 (or at POS controller 220) may be configured to validate the digital credits to the items purchased using credit registry 230 for example. As an illustrative example, credit interface logic 170 may be adapted to apply the credit as described in the ‘credit registry’ such as apply the credit only in certain select retailers, limit the amount of credit applied to any single purchase and/or limit how credits are applied (e.g., applied only for the purchase of selected items such as food products, excluding purchases of selected items such as cigarettes or alcohol, etc.). Examples of implementations of credit interface logic 170 may include, but are not limited or restricted to, software uploaded into POS terminal 210, hardware implemented as part of POS system 205, and/or software executed by a processing unit within the POS controller 220.

When implemented with validation functionality, credit interface logic 170 may be further adapted to review the digital credits to see if ‘valid’ items from select retailers as described within the ‘credit registry’ have been purchased for redemption. When ‘valid’ items have been purchased from select retailers, logic 170 applies credits to the item and reduces the total credits held by the registered recipient by a corresponding amount. The applied digital credits are then added to retailer redeemed account 190.

In the event that an item required for the redemption of digital credits be voided or returned within the transaction, the credit redemption will be reversed, and the digital credits will be returned to the recipient's holding account. The digital credits also will be removed from the retailer redeemed account 190.

2. No Credit Validation

According to another embodiment of the invention, after identification of the user, credit interface logic 170 implemented within POS terminal 210 (or POS controller 220) fetches the digital credits previously retained in storage unit 200 for possible redemption. These digital credits are not validated by credit interface logic 170 since such validation functionality is not implemented. Rather, when present, the digital credits are merely downloaded to POS system 205 for subsequent redemption.

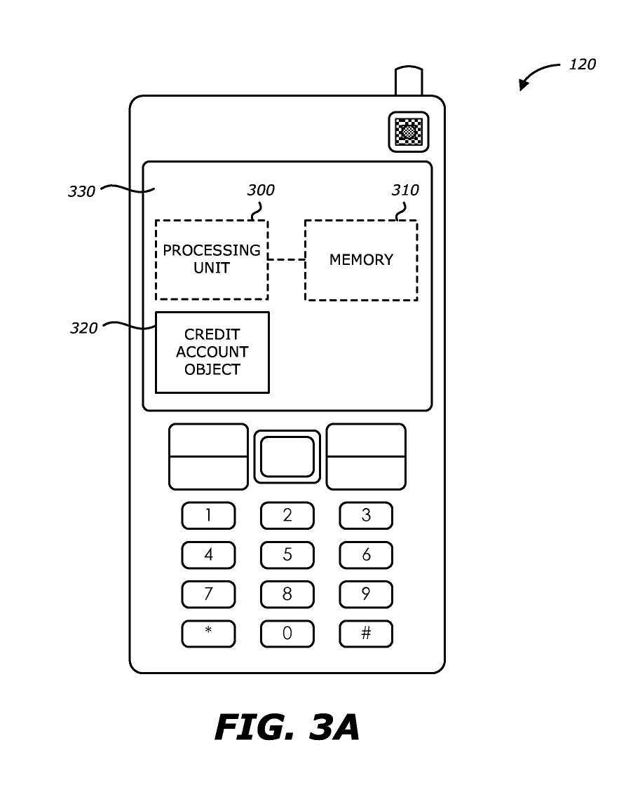

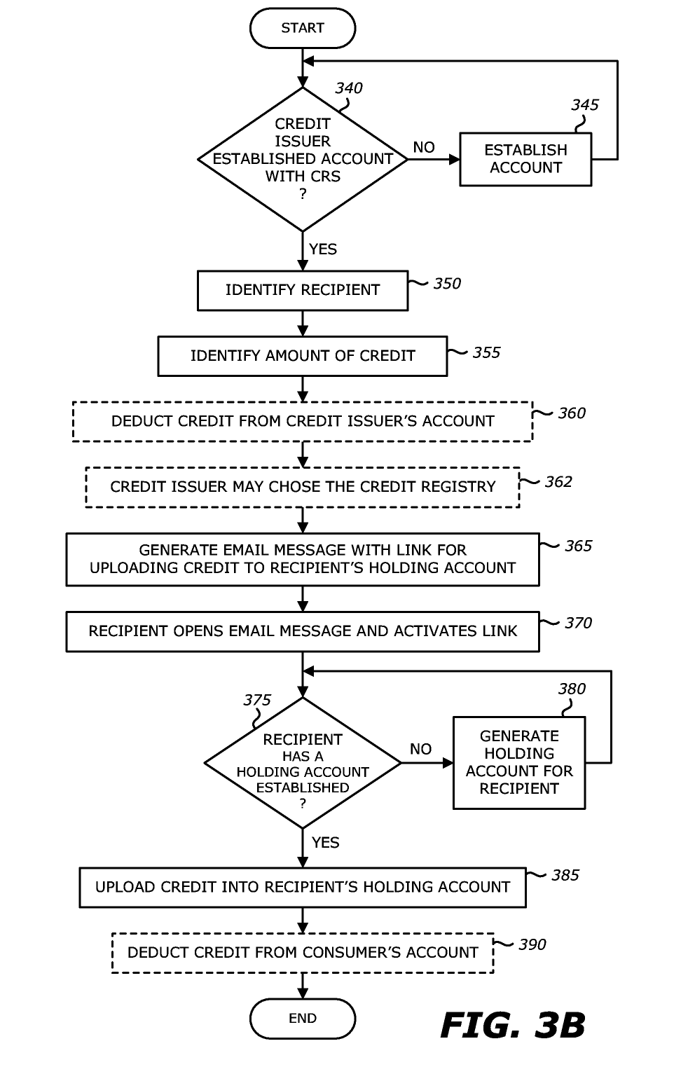

Referring now to FIGS. 3A-3B, exemplary embodiment of the architecture and operations for configuring electronic device 120 to support digital credit re-transmission is shown. With respect to FIG. 3A, electronic device 120 includes a processing unit 300 in communication with a memory unit 310. Memory unit 310 is a machine readable medium that is adapted to receive and store a software module (e.g., an application with an applet) that may be configured to generate an object 320 for display on a display screen 330 of electronic device 120 to more easily access and verify balances of the recipient's holding account. Object 320 may be used to receive, give and/or upload digital credits by establishing a secure communication path with credit storage unit 110 and 200 of FIGS. 1 and 2, respectively.

Herein, as shown in FIG. 3B, in order to provide credit to a targeted recipient, a registered user giving the credit (e.g., the credit issuer) needs to establish an account with the credit redemption system (CRS). This may be accomplished by visiting a prescribed website and selecting a registration icon or object. If an account is not established, the credit issuer needs to establish an account before proceeding (blocks 340 and 345). The account includes at least the name of the user, email address, a funding source (e.g., credit card number, debit card number, bank account routing number, PayPal® account, etc.), and a personal identification number (PIN) or password.

After an account is established, the credit issuer identifies the recipient(s) by providing identification information, such as an email address or a username, of the targeted recipient(s) and identifies the amount of the credit to be applied to each recipient (blocks 350 and 355). It is contemplated that one or more recipients may be listed, and thus, a credit is available to each of the recipients. This feature may be advantageous when the user wants full visibility of equal gifts as credits being provided to the recipients. Alternately, the credit issuer may choose to issue different amount of credits to each of the selected recipients. Optionally, although not shown, the user may select a pass-phrase or validation question with a corresponding answer to confirm that the recipient receives the email message. Also, at this time, the amount of the credit may be optionally deducted from the credit issuer's selected funding source (block 360).

As an additional option, the credit issuer may choose the ‘Credit Registry’ (block 362). The ‘Credit Registry’ may include one or more retailers and/or service providers where the credits may be used. The ‘Credit Registry’ may further provide one or more items, group of items or a ‘category’ of items within each of those retailers or service providers for which the credits may be applied.

Thereafter, a credit email message addressed to the identified recipient(s) is sent (block 365). The credit email message includes a mechanism that enables uploading of the credit to the recipient's holding account.

According to one embodiment of the invention, upon the recipient opening the credit email message, a uniform resource location (URL) link is present (block 370). Upon selecting of the link, a secure communication path is established with the credit storage unit to determine if the recipient has established a holding account in the credit redemption system (block 375). If an account is not established, the recipient is prompted to establish an account and the recipient needs to establish an account before proceeding (block 380).

Thereafter, the credit provided by the credit issuer is uploaded into the recipient's holding account which is accessible by retailers that are members of the CRS (block 385). Optionally, at that time, the amount of the credit may be deducted from the credit issuer's selected funding source (block 390) or, alternatively, when the recipient redeems the credit.

In another embodiment, an unregistered user may give a credit to a targeted recipient without establishing an account with the CRS. The unregistered user may visit a prescribed website and enter information pertaining to a targeted recipient such as the targeted user's username, email address, name, etc. Once the targeted user has been identified by the CRS, the unregistered user may enter his/her information pertaining to the desired payment method. For example, the unregistered user may want to send a $25 gift to a targeted user. To accomplish this without establishing an account with the CRS, the unregistered user may enter in his/her credit card information and the desired amount to give the targeted user.

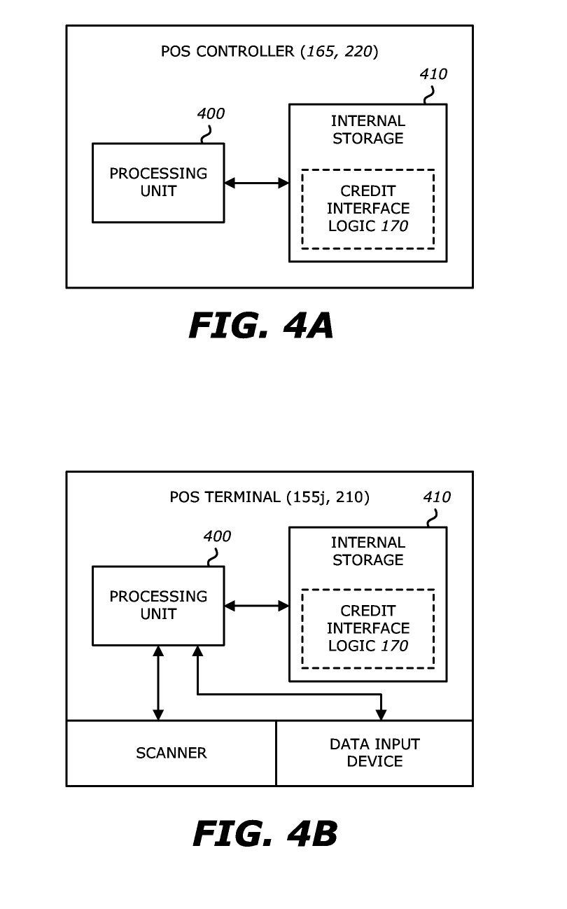

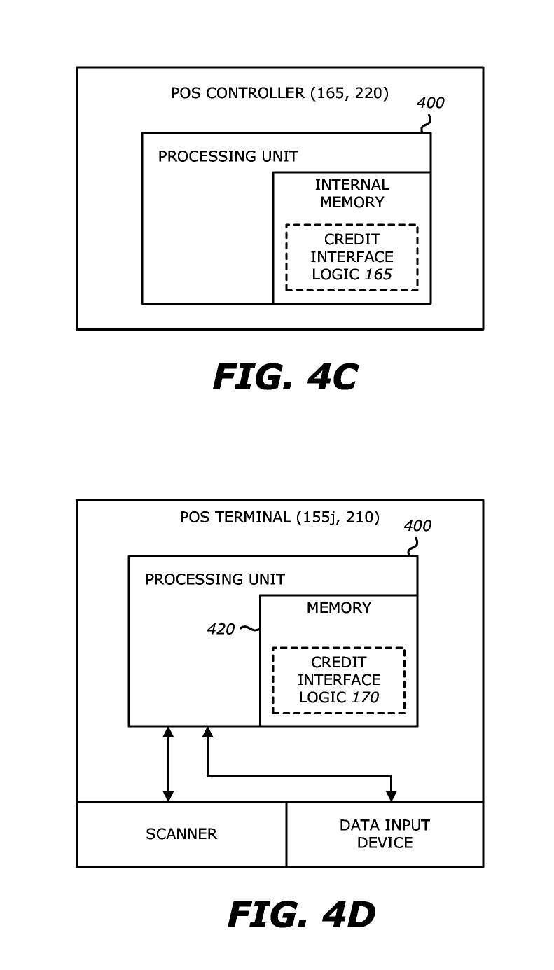

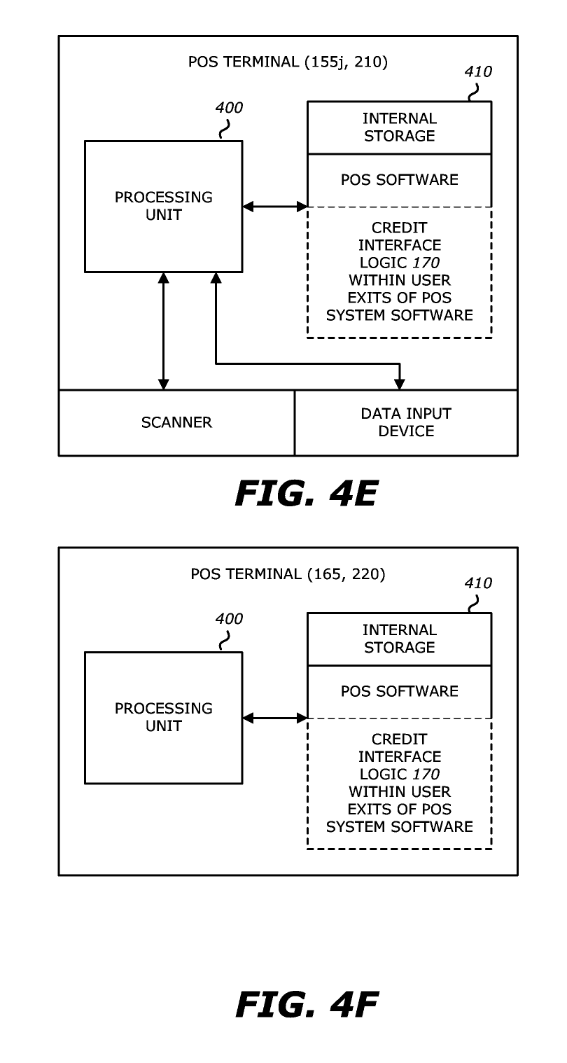

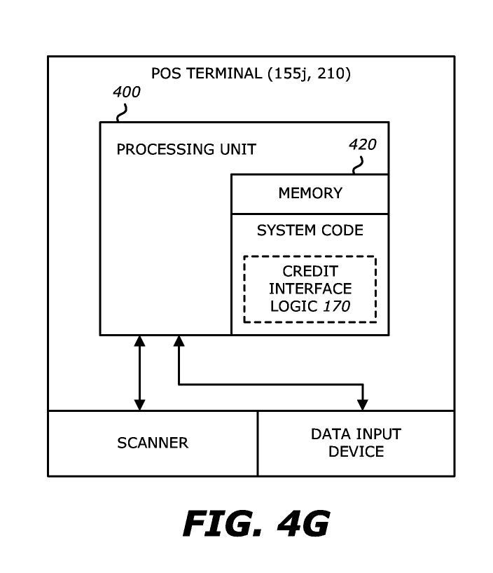

Referring now to FIGS. 4A-4G, exemplary embodiments of operations for configuring a retailer's POS system 150 of FIG. 1 or POS system 205 of FIG. 2 to support digital credit validation and clearance is shown. According to one embodiment of the invention, POS system 150 (or 205) comprises a controller 165 (or 220) that is adapted as a centralized processing unit for one or more POS terminals 155ⱼ/210. The implementation of credit interface logic 170 will vary based on the POS hardware and software being used by the retailer.

According to one potential implementation, as shown in FIGS. 4A and 4B, credit interface logic 170 may be a software module operating as a driver that is uploaded into internal storage 410 and executed by processing unit 400 of controller 165/220 (and/or each POS terminal 155ⱼ/210). Hence, controller 165/220 (and/or POS terminal 155ⱼ/210) can receive stored digital credits for an identified user.

According to another exemplary implementation, credit interface logic 170 may be a firmware that is installed in internal memory 420 of processing unit 400 implemented within controller 165/220 (and/or each POS terminal 155ⱼ/210) as shown in FIGS. 4C and 4D. Yet another exemplary implementation may feature the functionality of credit interface logic 170 being implemented within user exits of POS software on each POS terminal 155ⱼ/210 (and/or controller 165/220) as shown in FIGS. 4E and 4F. Yet another exemplary implementation, as shown in FIG. 4G, may include the functionality of credit interface logic 170 being implemented within system code that controls POS terminals 155ⱼ/210 of FIGS. 1 and 2.

Since the implementation will vary by POS system and in order to minimize its impact on the response times of POS system 150/205, credit interface logic 170 operates as a real-time interface to capture data from credit holding accounts and insert data into POS transactions. It may communicate with credit registry 230 for validation and decision making where implemented.

The data to be captured from POS transactions would be a transaction beginning and end, as well as any point where a total is performed; a transaction identifier; a POS number; a customer identification, such as a phone number, loyalty/club/frequent shopper card number, personal identification number (pin), credit card number, biometric data (e.g. fingerprint), or the like; purchased items including barcode number or PLU, quantity purchased, and unit price; credits redeemed; and voided items, credits, and transactions.

B. System Operation Flowchart

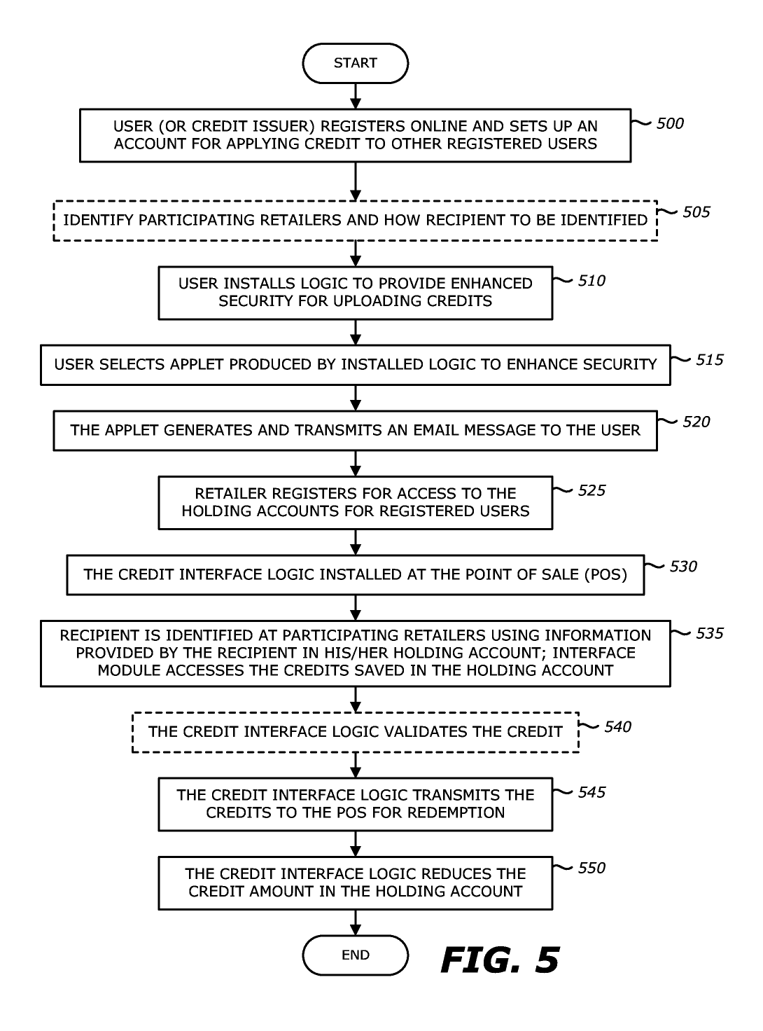

Referring to FIG. 5, an exemplary embodiment of the digital credit distribution and redemption process supported by the Credit Redemption System (CRS) is shown. First, the user registers with an entity to establish a credit holding account for retaining his/her digital credits (block 500). When setting up a credit holding account, the recipient may be allowed to select a ‘credit registry’ to identify the participating retailers where he or she intends to redeem credits and how the recipient shall be identified at these participating retailers (block 505). The method of identification may vary by retailer and includes one or more of the following: (1) retailer club/loyalty/frequent shopper card; (2) home telephone number; (3) mobile telephone number; (4) pin number; (5) biometrics (e.g. fingerprint); or (6) ATM/credit/debit card. After registration, the activation of a selected link within a credit email message would cause a secure communication path to be established between the electronic device and the credit storage unit to allow the credit to be applied to the recipient's holding account (item 520).

As an optional feature, the recipient may install logic on his/her electronic device to provide additional security to the credit transaction (block 510). As an illustrative example, a software application featuring an applet may be installed in the toolbox utility of the electronic device. According to one embodiment of the invention, the application may be downloaded from a website, although it is contemplated that the application may be downloaded from a portable recording medium (e.g., digital versatile disc “DVD”, compact disc “CD”, etc.). This application may include software underlying an applet that, when selected, provides enhanced security such as performing cryptographic operations on the credit information before transmission to the credit storage unit (block 515). These cryptographic operations may include encrypting the credit value, applying a digital signature recognized by the credit storage unit, or the like. Also, the application may allow the recipient easier access to his or her holding account.

In order to participate in the electronic redemption of digital credits, a retailer also registers with the CRS as a participating retailer (block 525). In addition, the retailer installs logic (e.g., credit interface logic) to function as an interface module and for communicating between the POS system at the retailer and holding accounts that are stored locally at the retailer or off-site (block 530). When implemented with validation functionality, this interface module will keep track of the items purchased and route the digital credits from the recipient's holding account.

When checking out at the retailer, the recipient identifies himself or herself at the POS terminal with one of the methods of identification that he has previously registered (block 535). At that time, the user identification is sent over a network connection to the holding accounts, and the credits previously retained in the user's holding account fetched for possible redemption.

As items are scanned/purchased on the POS terminal, the credit interface logic (also referred herein as the “interface module”) may be adapted to validate that the credits stored in the holding accounts are applied to the items to which the credits may be applied (block 540). If a ‘credit registry’ was selected, then the terms of the credit registry, such as the retailer and/or the items specified within the credit registry, may be validated with the retailer and the actual products purchased, to ensure that the terms of the credit registry are met, before the applicable credits are released to the POS system.

The interface module continually reviews the selected credits to see if ‘valid’ items from select retailers have been purchased for redemption. When ‘valid’ items from select retailers have been purchased to redeem a credit, the interface module transmits the credit to the POS terminal (block 545). The credit is then added to the retailer's redeemed credit account and the credit interface logic reduces the credit amount in the recipient's holding account by a corresponding amount (block 550). Where validation is not provided, the interface module merely downloads the recipient's digital credits to the POS terminal without the validation as described above.

Should an item required for the redemption of a credit be voided or returned within the transaction, the credit redemption will be reversed, and the credit will be returned to the user's holding account. The credit will be removed from the retailer redeemed account.

Referring now to FIG. 6, an exemplary embodiment of issuing and activating a reloadable prepaid debit/gift card linked to the registered user's holding account is depicted. First, the CRS checks to determine whether the user is a new user or is a registered user (block 600). If the user is a new user, and hence not registered, the user is routed to register with the CRS and establish a holding account (block 610). The newly registered user then establishes, via an API or a similar method, links with debit/credit card issuers such as Visa, Master Card, or American Express (block 620). The CRS then issues the registered user a reloadable prepaid debit/credit card that is linked to the registered user's holding account (block 630). Upon issuance, the physical card will be mailed to the recipient (directly by the third party payment solutions provider or CRS) and an email will be sent with the necessary information for validation, if applicable, and confirmation. Finally, the CRS or third party payment solutions provider may require the registered user to validate the reloadable prepaid debit/credit card before it is activated (block 640). The validation may require the recipient to enter a PIN (Personal Identification Number) and call in to activate the card for security purposes. Optionally, the registered user may choose to, in addition to receiving the reloadable prepaid debit/credit card linked to the registered user's holding account, establish a link with PayPal™, Square®, or a similar payment processing service (blocks 650-670).

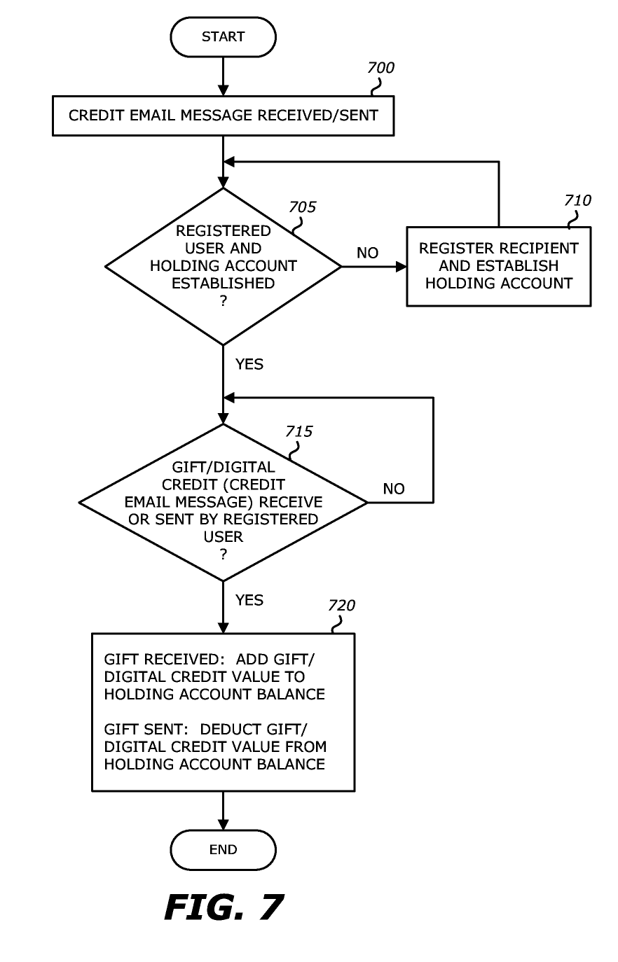

Referring now to FIG. 7, an exemplary embodiment of adding or subtracting the value of gifts/digital credits received or sent via credit email message is shown. When a recipient clicks on the link provided in the credit email message, it takes them to their holding account and requests them to login with their username and password (blocks 700 and 705). All gifts/digital credits received by the recipient from other registered users and all other sources will be added to the digital credit balance in his/her holding account (blocks 710 and 715). Similarly, when a registered user sends a gift, a credit email message is sent to the recipient and the value of the gift/digital credit given is subtracted from the balance in the holding account of the registered user who sent the gift (blocks 710 and 715).

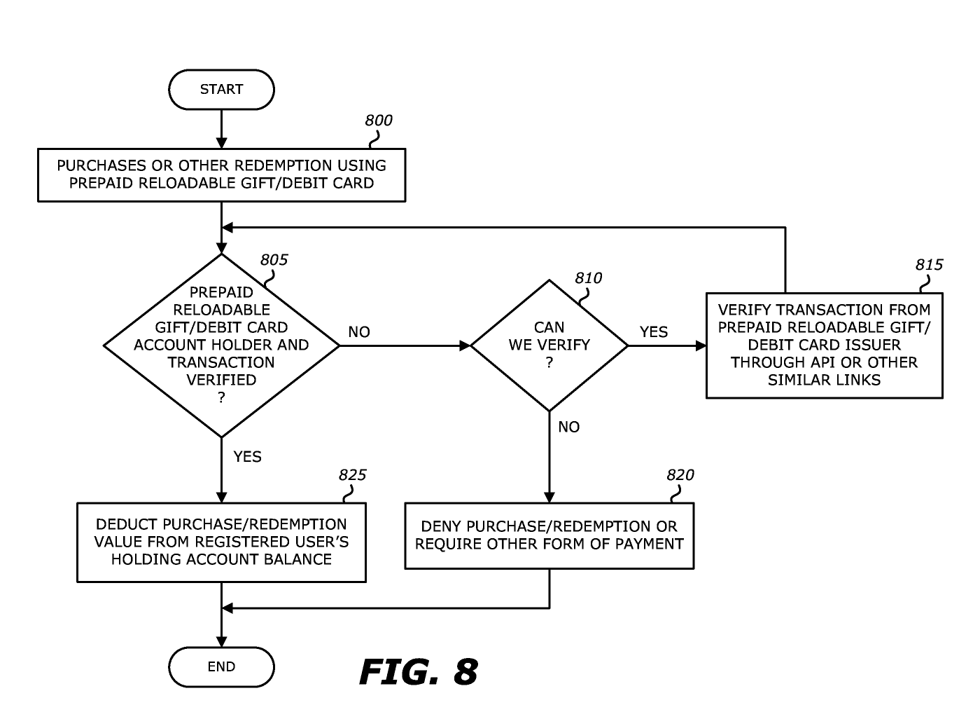

Referring now to FIG. 8, an exemplary process illustrating purchases and all other redemptions via a ‘Universal Prepaid Reloadable Gift/Debit Card’ is shown. A Universal Prepaid Reloadable Gift/Debit Card can be used by registered users of the CRS just like any other gift or debit card (800). All charges, purchases and redemptions using this ‘Universal Reloadable Prepaid Gift Card’ will be verified via an application programming interface (API) and similar links to card-issuing companies like Visa, Master Card, American Express, etc. (block 805). If the transaction has not been verified, the CRS or POS terminal determines whether the transaction may be verified (810). For example, the PIN pertaining to the holding account attached to the Universal Prepaid Reloadable Gift/Debit Card may not match the PIN that was enter at the POS terminal and the registered user may be required to re-enter the PIN. The CRS or POS terminal then attempts to verify the transaction again (815). If the transaction cannot be verified, the purchase may be denied or the registered user may be required to use another form of payment (820). One example of a situation in which the transaction cannot be verified would be if the registered user enters the wrong PIN several times and, as a safety precaution, the CRS temporarily deactivates the Universal Prepaid Reloadable Gift/Debit Card. However, if the transaction was verified, the balance of digital credits in the recipient's holding account will be reduced for the value of purchases and other redemptions via ‘Universal Reloadable Prepaid Gift/Debit Card’ (block 825).

For example, if a registered user makes a purchase from a retail member using his/her Universal Prepaid Reloadable Gift/Debit Card, the retail member or the CRS will verify the transaction by verifying the registered user has sufficient digital credits in his/her holding account to pay for the purchase. If the registered user does not have sufficient funds, the retail member may allow the registered user to pay for the remaining balance on the purchase by any other means, such as with a credit card or cash. Once the transaction is verified, the CRS will deduct digital credits from the registered user's holding account pertaining to that specific retail member equal to the amount of the purchase and credit that amount to the retail member. To expand further, if the registered user has $50 in digital credits for Retail Member A and $25 in digital credits for Retail Member B, a $45 purchase at Retail Member A will leave the registered user with $5 in digital credits for Retail Member A and $25 in digital credits for Retail Member B.

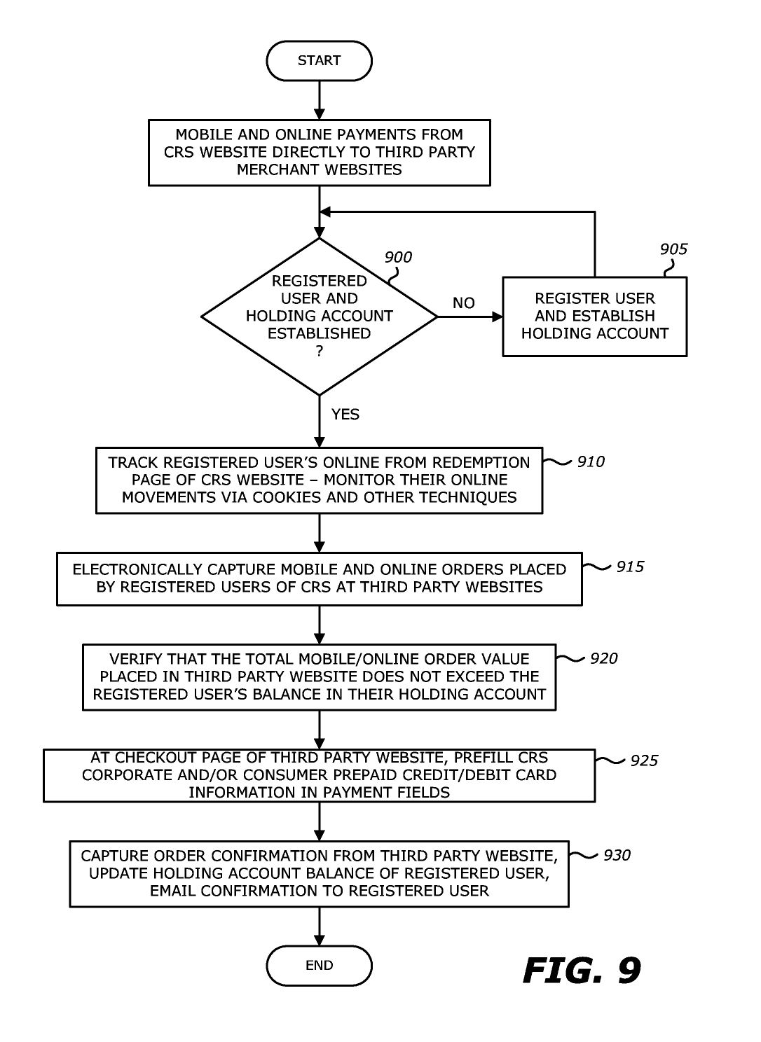

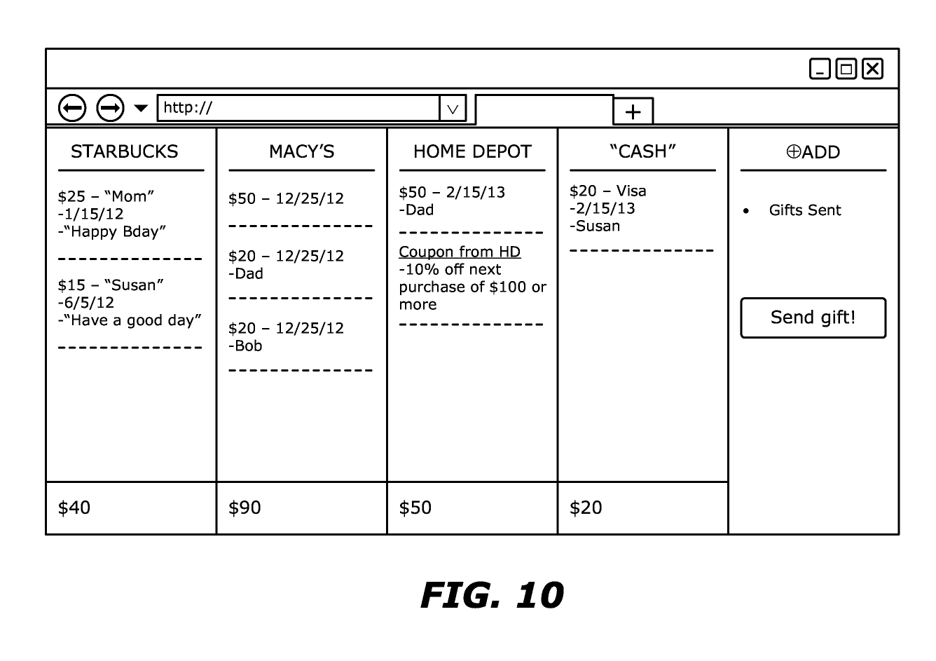

Referring now to FIG. 9, an exemplary embodiment of the process of applying the digital credits from the holding account directly to third party merchant websites for online purchases is shown. A registered user with an established holding account can go to any merchant website from the redemption page of a CRS website (block 910). When a registered user logs into his/her holding account, the CRS installs cookies and other well-known tools on the registered user's electronic device in order to monitor and keep track of the registered user's movements online (block 910). On a third party merchant website, the CRS electronically captures all orders placed online by the registered user (block 915). The CRS verifies that the total value of the order does not exceed the balance in the holding account of the registered user when the order is placed by registered user at a checkout page of a third party merchant website, (block 920). The registered user may have the option to pay a partial amount of the online order value from his/her ‘Holding Account’ and the remaining balance of the order through another means. While the CRS may pre-fill the shipping address of the registered user from a CRS database, the registered user may optionally enter another shipping address. The CRS will electronically complete the payment fields on behalf of the registered user by entering the registered user's prepaid debit card information or the CRS corporate credit/debit card information, including the registered user's or CRS corporate credit/debit card number, security code, expiration date, billing address of the registered user or CRS credit/debit card, etc. (block 925). When the CRS corporate credit/debit card is used, the shipping address may not match the credit/debit card billing address, then CRS will enter the item as a ‘gift’ to be shipped to the shipping address designated by the registered user. The CRS will capture an order confirmation, reduce the holding account balance by the value of online order paid directly by the CRS to a third party merchant online, and email the order confirmation to the registered user (block 930).

In another embodiment of the invention, the holding account of the registered user is further divided into sub-accounts with each sub-account corresponding to a separate retail member. In such an embodiment, the gift cards corresponding to a first retail member will be deposited into the sub-account corresponding to the first retail member. As an example, if a registered user has established sub-accounts with retail members Macy's and Home Depot, a gift card for $50 at Macy's received by the registered user will be deposited into the sub-account corresponding to Macy's and the sub-account corresponding to Home Depot will be unaffected. Furthermore, a purchase made at Macy's with the holding account would result in the purchase amount being deducted from the sub-account corresponding to Macy's.

In yet another embodiment of the invention, multiple retail members may enter into an agreement in which the amounts in a registered user's sub-accounts corresponding to any of the retail members involved in the agreement may be interchangeable among sub-accounts corresponding to those retail members. As an illustrative example, Macy's and Home Depot may enter into an agreement in which the amounts in a registered user's sub-accounts corresponding to Macy's and Home Depot are interchangeable between the sub-accounts of the two retail members. This implies that a user may freely transfer funds from the sub-account corresponding to Home Depot to the sub-account corresponding to Macy's. The CRS may also automatically realize that the balance in the sub-account of one retail member is less than the purchase amount for a purchase at that retail member and apply funds from a second retail member if the two retail members are in agreement to do so. For example, if the user is attempting to use his/her holding account for a $100 purchase at Home Depot and the user only has $80 in his/her sub-account corresponding to Home Depot, the CRS may automatically apply $20 from the sub-account from Macy's to the purchase. This embodiment is useful to a registered user when the user receives a gift card corresponding to a retail member at which the user does not regularly shop. This would allow the user to apply the gift card to a sub-account of the retail member and prevent the gift card from going to waste. In this case, those retail members not involved in the agreement would not be affected. For example, if Starbucks was not a party to the agreement between Macy's and Home Depot, although the user may transfer funds freely between the sub-accounts corresponding to Macy's and Home Depot, the user would not be able to transfer funds to the sub-account corresponding to Starbucks from other sub-accounts or from the sub-account corresponding to Starbucks to other sub-accounts.

In some embodiments, a registered user may access his/her holding account from an application installed on his/her electronic device. The application may include an Internet browser such as Internet Explorer or Mozilla Firefox or an application developed specifically for the type of electronic device used to display only information related to the CRS.

The application may also contain a screen containing information regarding the total amount of digital credits the registered user's holding account contains for each member retailer. Referring to FIG. 10, an exemplary illustration of a website viewed on an electronic website displaying a user's holding account is depicted. In FIG. 10, the website illustrates a holding account separated into sub-accounts with past transactions displayed. For instance, the amount of a transaction, the date on which the transaction occurred, other parties involved, and a message about the transaction may be included on the webpage.

The application may also contain a screen that graphically illustrates the various digital credits the registered user has sent and/or received. This graphical illustration would allow the registered user to easily access who has sent the registered user a gift if the registered user desires to reciprocate the gesture. Furthermore, the registered user would easily be able to determine if another registered user sent a digital credit gift as a birthday gift or a gift for another holiday.

In yet another embodiment of an application displaying information pertaining to a user's holding account on an electronic device, the application may alert the user of his/her balance in a sub-account when the user enters the store to which the sub-account corresponds. For instance, if the electronic device is of the type that is likely to be carried around by the user, e.g., a cellular phone, the application may use the location services of the electronic device to determine whether the user is near or has entered a physical store pertaining to a sub-account within the user's holding account. As an example, a user may carry his/her cellular phone that has location services, such as a global positioning system (GPS), in his/her pocket. When the user enters the parking lot of or a physical building of a retail member, e.g., Home Depot, and the user has a sub-account with the retail member, the application can automatically notify the user of the current balance in the sub-account. This would prevent the user from making a purchase at the store without realizing he/she had a balance in his/her holding account that could have been applied to the purchase.

While the invention has been described in terms of several embodiments, the invention should not be limited to only those embodiments described, but can be practiced with modification and alteration within the spirit and scope of the appended claims set forth in the subsequent non-provisional application. The description is thus to be regarded as illustrative instead of limiting.

What is claimed is:

1. A method of maintaining a credit redemption system comprising:
receiving a transmission from a user that includes an amount on a gift card, wherein a gift card is one of a physical card associated with a credit value or an electronic message associated with a credit value;
verifying the user has established an account;
summating the amount on the gift card with a value in a sub-account of the user's account, wherein the sub-account is one of a plurality of sub-accounts within the user's account; and
storing the summated value in the sub-account.

2. The method of claim 1 further comprising:
receiving a purchase request from the user corresponding to a first retail member, wherein the purchase request includes an amount and one or more terms of purchase;
transmitting the amount and the one or more terms of purchase to the first retail member; and
deducting the amount of the purchase request from the sub-account corresponding to the first retail member.

3. The method of claim 2 wherein the first retail member has established an account and the purchase request amount is transferred to the account of the first retail member.

4. The method of claim 2 wherein the purchase request amount may be deducted from one of a plurality of sub-accounts corresponding to a plurality of retail members.

5. The method of claim 2, wherein, in response to receiving the purchase request, a credit interface logic at a point-of-sale (POS) terminal (i) fetches one or more digital credits stored in one of the plurality of sub-accounts within the user's account, and (ii) transfers the one or more digital credits to the POS terminal.

6. The method of claim 1 wherein the gift card is directed to the first retail member.

7. The method of claim 6 wherein the sub-account corresponds to the first retail member, wherein only amounts on gift cards directed to the first retail member may be summated with the value in the sub-account, and only (1) purchase request amounts included in purchase requests corresponding to the first retail member or (2) gifts sent corresponding to the first retail member may be deducted from the sub-account.

8. The method of claim 6 wherein the first retail member has paired with a second retail member such that the amount on a gift card directed to either retail member may be applied to the sub-account corresponding to either retail member.

9. The method of claim 1 further comprising:
maintaining a record of transactions for the user corresponding to a sub-account, wherein the record includes the date of each transaction and any participant to the transaction.

10. The method of claim 9 wherein each transaction includes at least one of purchase request amounts deducted from the sub-account, gift card amounts added to the sub-account, or gift amounts transferred from the sub-account to a third-party.

11. The method of claim 10 wherein the gift amounts transferred from the sub-account are transferred to an account of the third-party.

12. The method of claim 1 further comprising:
transmitting an electronic message to the user notifying the user of the value in the sub-account.

13. The method of claim 1 further comprising:
receiving a request to transmit a gift to a second user from the user;
verifying the amount in the user's sub-account is greater than or equal to the gift;
transmitting the gift to the second user; and
deducting an amount equal to the gift from the sub-account.

14. The method of claim 1 further comprising:
receiving a transmission that includes a second amount to be added to one of the plurality of sub-accounts of the user's account;
summate the second amount with a value in the one of the plurality of sub-accounts of the user's account to generate a second summated value; and
store the second summated value in the one of the plurality of sub-accounts of the user's account.

15. The method of claim 1, wherein the amount on the gift card is not restricted to a single sub-account of the plurality of sub-accounts of the user's account.

16. A non-transitory computer-readable storage medium storing instructions that, when executed by a processing unit, cause an electronic device to:
receive a transmission from a user that includes an amount on a gift card, wherein a gift card is one of a physical card associated with a credit value or an electronic message associated with a credit value;
verify the user has established an account;
summate the amount on the gift card with a value in a sub-account of the user's account, wherein the sub-account is one of a plurality of sub-accounts within the user's account; and
store the summated value in the sub-account.

17. The non-transitory computer-readable storage medium of claim 16 further comprising:
receive a purchase request from the user corresponding to a first retail member, wherein the purchase request includes an amount and one or more terms of purchase;
transmit the amount and the one or more terms of purchase to the first retail member; and
deduct the amount of the purchase from the sub-account.

18. The non-transitory computer-readable storage medium of claim 17 wherein the first retail member has established an account, and the amount and the one or more terms of purchase are transferred to the account of the first retail member.

19. The non-transitory computer-readable storage medium of claim 16 wherein the gift card is directed to the first retail member.

20. The non-transitory computer-readable storage medium of claim 19 wherein the sub-account corresponds to the first retail member, wherein only amounts on gift cards directed to the first retail member may be summated with the value in the sub-account, and only purchase request amounts included in purchase requests corresponding to the first retail member may be deducted from the sub-account.

21. The non-transitory computer-readable storage medium of claim 16 further comprising:
maintain a record of transactions for the user corresponding to a sub-account, wherein the record includes the date of each transaction, one or more terms and conditions of purchase and any third-party participant.

22. The non-transitory computer-readable storage medium of claim 21 wherein each transaction includes at least one of purchase request amounts deducted from the sub-account, gift card amounts added to the sub-account, or gift amounts transferred from the sub-account to a third-party.

23. The non-transitory computer-readable storage medium of claim 22 wherein the gift amounts transferred from the sub-account are transferred to an account of the third-party.

24. The non-transitory computer-readable storage medium of claim 16 further comprising:
transmit an electronic message to the user notifying the user of the value in the sub-account.

25. The non-transitory computer-readable storage medium of claim 16 further comprising:
receive a request to transmit a gift to a second user from the user;
verify the amount in the user's sub-account is greater than or equal to the gift;
transmit the gift to the second user; and
deduct an amount equal to the gift from the sub-account.

26. A method comprising:
receiving a transmission from a user that includes a request to view an account of the user;
verifying the user established the account;
presenting the user with a webpage enabling the user to manage the account of the user; and
electronically entering gift card information of the user at a checkout page to facilitate online and mobile purchases by the user.

27. The method of claim 26 wherein managing the account of the user includes at least one of (1) viewing past transactions, (2) increasing an amount in one of a plurality of sub-accounts of the user's account, (3) sending a gift from any sub-account, (4) adding a new sub-account, (5) removing a sub-account, or (6) electronically entering the gift card information of the user at the checkout page of third party websites to facilitate online and mobile purchases by the user.

28. A method comprising:
polling a location service located on an electronic device of a registered user at regular intervals;
comparing a current location returned from the location service to known locations of a plurality of retail members; and
notifying the registered user, with the electronic device, that the current location corresponds to a known location of at least one of the plurality of retail members,
wherein the user has a sub-account within a user account corresponding to at least one of the plurality of members to which a known location corresponds to the current location.
